(19) United States
(12) Patent Application Publication
(10) Pub. No.: US 2004/0085530 A1
(43) Pub. Date: May 6, 2004

(54) Optical monitoring apparatus

(75) Inventors: Ingolf Braune, Gundelfingen (DE); Martin Wuestefeld, Sexau (DE); Roland Bergbach, Emmendingen (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sick AG, Waldkirch/Breisgau (DE)

(21) Appl. No.: 10/653,529

(22) Filed: Sep. 2, 2003

(30) Foreign Application Priority Data
Oct. 30, 2002 (DE) 202 16 757.7

(51) Int. Cl. G01J 1/00

(52) U.S. Cl. 356/213

(57) ABSTRACT

An optical monitoring apparatus has a light transmitter for the transmission of at least two light beams offset substantially parallel to one another into a protected zone as well as a light receiver for the for the reception of the transmitted light beams and for the outputting of corresponding received signals. The light receiver has at least one photo-sensitive element having an elongate light-sensitive region whose elongate direction is aligned parallel to the arrangement of the light beams perpendicular to the direction of transmission such that all radiated light beams can be completely detected by the light sensitive region. A control circuit is provided for the distinguishing of the light beams which causes the light transmitter to make a transmission of the light beams offset in time.

The invention relates to an optical monitoring apparatus comprising a light transmitter for the transmission of light into a protected zone and a light receiver for the reception of the transmitted light and for the outputting of corresponding received signals.

Such monitoring apparatuses are used, for example, for the securing of a bending press. In such a bending press, an upper tool formed as a bending tool is moved, for example in a vertical direction, toward a stationary lower tool at which a workpiece to be worked by the bending tool is held.

For the protection of a person who inserts workpieces into the bending press, a light transmitter and a light receiver are attached to the upper tool. The light transmitter and the light receiver are usually installed at the upper tool with the help of holding arms and together they form a light barrier. A protected zone can be monitored by this light barrier which is adjacent to the edge of the upper tool facing toward the lower tool, the so-called bending line. If an undesired object is detected in the protected zone between the bending tool and the lower tool, the movement of the upper tool in the direction of the lower tool is stopped by an apparatus control. A jamming of objects or body parts between the upper tool and the lower tool is prevented in this manner.

The slowing down of the movement of the upper tool cannot take place instantaneously due to the inertia of the upper tool. The path which is necessary to brake the bending tool from its regular movement down to a standstill is called a lag way or lag path. To provide effective protection against injury, the light of the light barrier is therefore transmitted at the spacing of the lag path beneath the bending line of the bending tool.

With known light barrier systems, a plurality of light transmitters and a corresponding number of light receivers are frequently used for the monitoring of an expanded protected zone in order to be able to transmit and detect a corresponding number of light beams spaced apart from one another. However, this increases the complexity of the monitoring system.

It is the underlying object of the invention to provide an optical monitoring apparatus having increased reliability and increased safety which has a design which is as simple as possible.

An optical monitoring apparatus having the features of claim 1 is provided to satisfy the object.

The optical monitoring apparatus in accordance with the invention has a light transmitter for the transmission of at least two light beams offset to one another in a substantially parallel manner into a protected zone and a light receiver for the reception of the transmitted light beams and for the outputting of corresponding received signals, with the light receiver having at least one photo-sensitive element with an elongate light-sensitive region whose longitudinal direction is aligned parallel to the arrangement of the light beams perpendicular to the direction of transmission such that all radiated light beams can be completely detected by the light-sensitive region, and with a control circuit being provided at the light receiver for the distinguishing of the light beams, said control circuit causing the light transmitter to make a transmission of the light beams offset in time.

In accordance with the invention, the use of at least two light beams offset substantially parallel to one another and of at least one photo-sensitive element is therefore provided whose light sensitive region is made so elongate that all radiated light beams can be completely detected by this one light sensitive region.

Due to the transmission of a plurality of light beams offset to one another, a larger protected zone can be monitored, on the one hand, and a protected zone can be monitored with a higher spatial resolution, on the other hand.

In the case of a bending press, for example, a first light beam can extend parallel to the lower side of the bending tool spaced from the lag path and a second light beam can extend at a larger spacing thereto.

It would vice versa likewise be possible to transmit a first light beam parallel to the lower side of the bending tool spaced apart from the lag path and to transmit a second light beam at a lower spacing, that is therefore between the lower side of the bending tool and the first light beam. Even if the bending tool approaches the lower tool up to the spacing of the lag path or beyond and if the first light beam can consequently no longer actively participate in a monitoring, a human finger or other object which has come between the bending tool and the lower tool can still be detected by the second light beam. The monitoring apparatus in accordance with the invention contributes to increased labor safety in this manner.

Since all transmitted light beams are detected by a single light sensitive region, a radiation of the light beams offset in time is provided for the distinguishing of the individual light beams at the light receiver. The identification of the individual light beams in accordance with the invention does not therefore take place in that each light beam has a different wavelength or in that each light beam has its own light sensitive region associated with it, but solely by the control circuit which causes the light transmitter to make a transmission of the light beams offset in time. There is therefore only one single light receiver necessary. The apparatus design of the monitoring apparatus in accordance with the operation is thereby simplified such that the monitoring apparatus can be produced and installed with a low economic effort.

At the same time, the monitoring apparatus is insensitive toward oscillations of the light beams in the longitudinal direction of the light sensitive region of the photosensitive element. Depending on the dimensioning of the elongate design of the light sensitive region, the light beams can move to and fro over the whole length of the light sensitive region in each case at the location of the receiver without leaving the light sensitive region and thereby erroneously triggering an alarm signal which would falsely result, for example, in a braking of the of the bending tool of a bending press. The reliability of the monitoring apparatus in accordance with the invention is thereby increased and downtimes, for example of a bending press, are reduced. This effect is particularly advantageous when the elongate direction of the light sensitive region corresponds to a vertical direction since the explained oscillations typically occur particularly strongly in the vertical direction.

Advantageous embodiments of the invention can be seen from the dependent claims, from the description and from the drawing.

In accordance with a preferred embodiment of the invention, the light transmitter comprises a light source and a diaphragm arrangement by which in each case a light beam to be transmitted can be selected from the light of the light source. Since only one light source is provided, the number of required components of the monitoring apparatus in accordance with the invention is reduced. This further reduces the economic effort for the manufacture of the monitoring apparatus, on the one hand, and increases the reliability of the apparatus, on the other hand. The diaphragm arrangement represents a simple means to separate the light beams out of the light of the light source.

The diaphragm arrangement advantageously has an electronically controllable intensity filter. Such intensity filters can be switched particularly fast so that the individual light beams can be transmitted at short time intervals to one another.

The diaphragm arrangement preferably has an LCD shutter. Such a shutter cannot only be switched particularly fast, but the form of the shutter aperture can also be set variably such that the cross-sectional shape of the light beams can be set in the plane perpendicular to the direction of radiation.

The light beams can be adjacent to one another or overlap one another at least regionally. The protected zone can thereby be monitored practically without interruption.

In accordance with a particularly advantageous embodiment of the invention, the light receiver has a plurality of photo-sensitive elements which are arranged in a row next to one another with a parallel alignment of the light sensitive regions. The monitoring apparatus is thereby not only tolerant with respect to oscillations in the longitudinal direction of the light sensitive regions, but also in a direction perpendicular thereto. If a radiated light beam therefore migrates out of the light sensitive region transversely to the longitudinal direction of the light sensitive region, it is detected by the respectively adjacent light sensitive region.

In accordance with a further preferred embodiment of the monitoring apparatus in accordance with the invention, the light transmitter and the light receiver are arranged at the same side of the protected zone and the transmitted light beams can be deflected in the direction of the light receiver by at least one reflector arranged at the respectively opposite side of the protected zone. By the arrangement of the light transmitter and of the light receiver at the same side of the protected zone, both can be made in one construction unit, which makes a compact design possible. Furthermore, no large adjustment effort is required since the light transmitter only has to be aligned approximately to the reflector. If a suitable reflector material is used, for example a retro-reflecting foil, it can easily be ensured that the transmitted light beams can be detected by the light receiver.

A separate reflector can be associated with each light beam.

It is particularly advantageous for at least one reflector, and in particular each reflector, to have an encoding along a direction perpendicular to the offset arrangement of the light beams. It can be determined at the light receiver by the encoding of the light beams produced at the reflector whether a light beam has actually passed through the whole protected zone. If, for example, a light beam is reflected at a foreign body located in the protected zone, but no encoding of the light beam is found, an alarm signal is output despite the detected light beam, said alarm being able, in the case of a bending press for example, to result in a braking of the bending tool. This increases the security of the monitoring apparatus.

The light receiver is preferably integrated in the light transmitter. A particularly compact design of the monitoring apparatus is thereby achieved.

The invention will be described by way of example in the following and with reference to the enclosed drawing. There are shown:

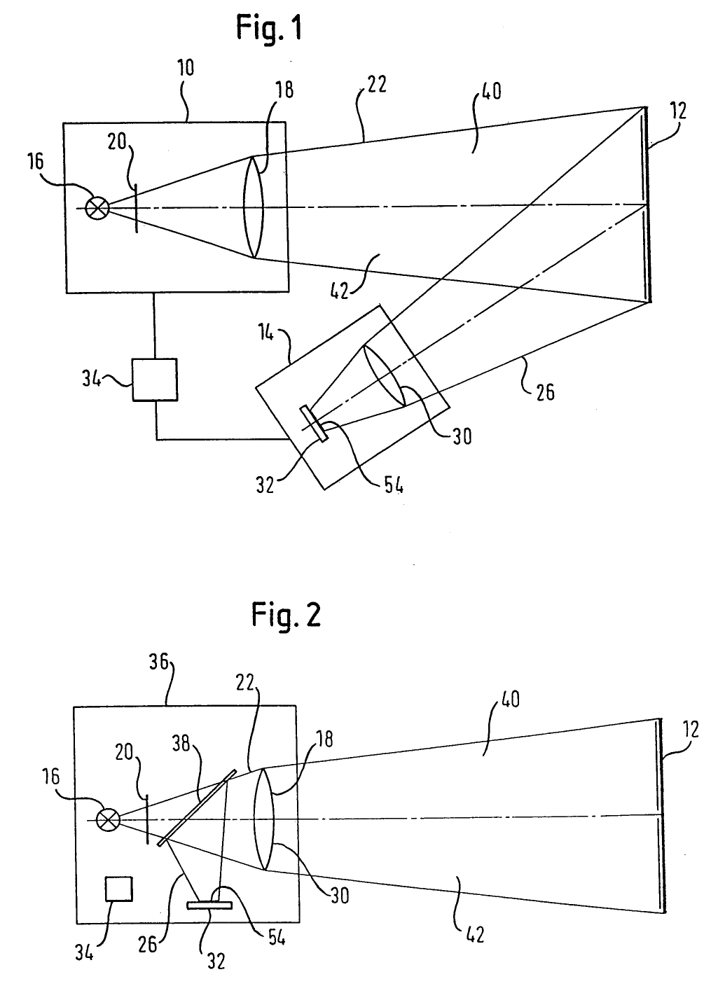

FIG. 1 a schematic representation of a first embodiment of the monitoring apparatus in accordance with the invention;

FIG. 2 a schematic representation of a second embodiment of the monitoring apparatus in accordance with the invention;

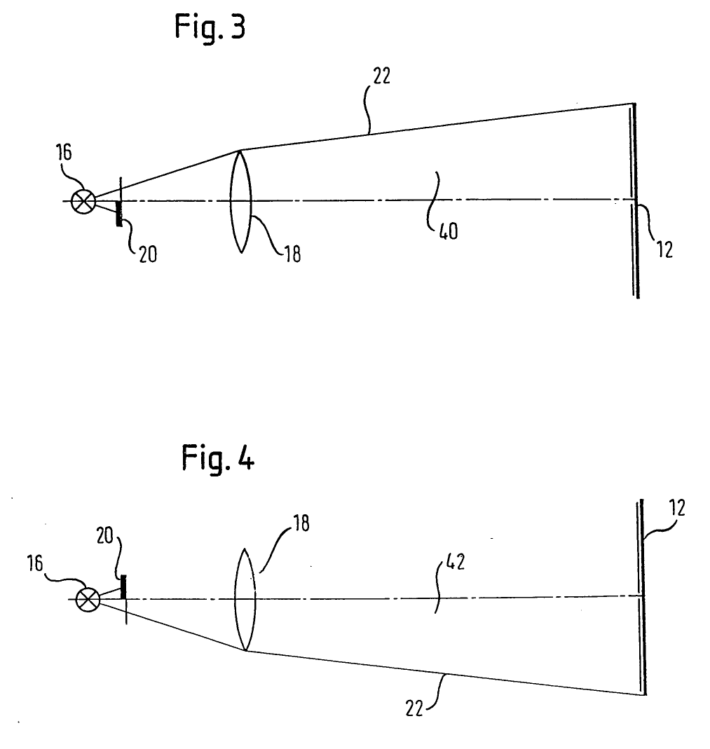

FIGS. 3 and 4 schematically, the function of a diaphragm arrangement of the monitoring apparatus of FIGS. 1 or 2;

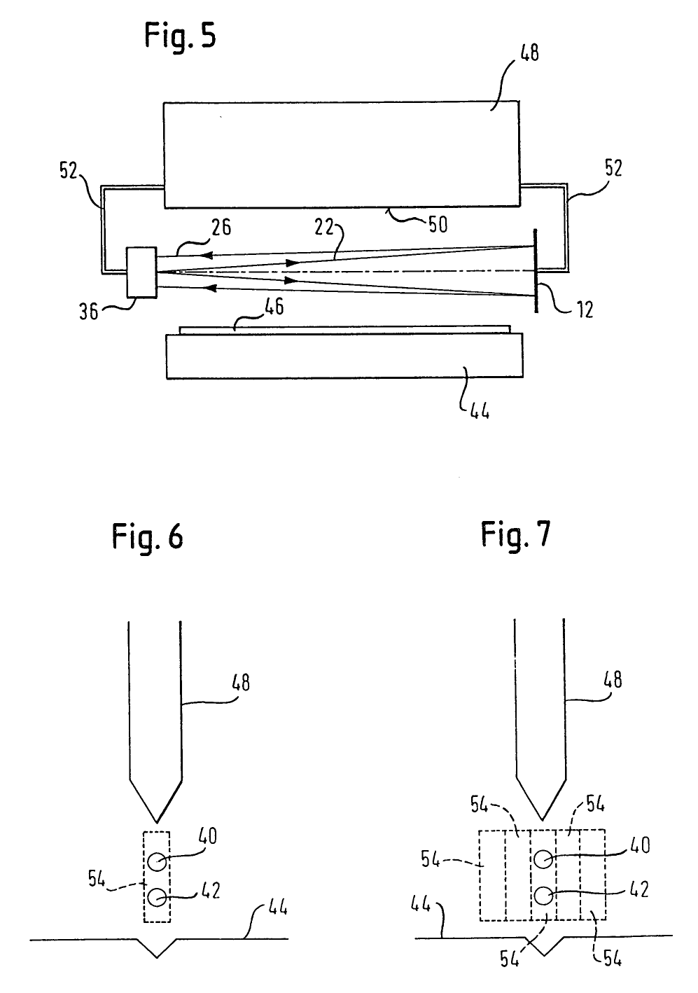

FIG. 5 the arrangement of the monitoring apparatus of FIG. 2 at a bending press;

FIG. 6 a section through the arrangement of FIG. 5 perpendicular to the radiation direction of the light beams of the monitoring apparatus at the location of the light receiver; and

FIG. 7 the section of FIG. 6 with an alternative embodiment of the light receiver.

A first embodiment of the optical monitoring apparatus in accordance with the invention is shown in FIG. 1. The material elements of the monitoring apparatus are a light transmitter 10, a reflector 12 and a light receiver 14.

The light transmitter 10 includes a light source 16 for the transmission, in particular the pulse-like transmission, of infrared light, for example. Light emitting diodes or semiconductor lasers can be used as suitable light sources 16, for example. The light 22 transmitted by the light source 16 exits the light transmitter 10 via an optical lighting system 18, for example via a lens system. The light passes through a diaphragm arrangement 20 which is arranged between the light source 16 and the optical lighting system 18 and its function will be explained in more detail further below.

The light 22 radiated from the light transmitter 10 passes through a protected zone to be monitored before being incident on the reflector 12. The reflector 12 can, for example, have a retro-reflecting foil.

The light 26 reflected by the reflector 12 is detected by the light receiver 14. For this purpose, the light receiver 14 has a suitable optical imaging system 30, for example a lens system, which images the reflected light 26 onto a photo-sensitive element 32 having a light-sensitive region 54.

The monitoring apparatus in accordance with the invention works in the manner of a light barrier, i.e. it is determined whether the light 22 transmitted by the light transmitter 10 is detected, as expected, as reflected light 28 by the light receiver 14, or whether it is prevented from being incident on the photo-sensitive element 32 of the light receiver 14 by an object which has intruded into the protected zone. The light receiver 14 has a suitable evaluation unit, which is not shown in FIG. 1, for the evaluation of the light signals detected by the photo-sensitive element 32.

Since a transmission of light beams 40, 42, offset in time is provided in accordance with the invention, the light transmitter 10 and the light receiver 14 are connected to one another via a control circuit 34 which controls the radiation of the light beams 40, 42 from the light transmitter 10, on the one hand, and herewith synchronizes the reception of the reflected light 26 by the light receiver 14, on the other hand.

In the first embodiment of the monitoring apparatus in accordance with the invention shown in FIG. 1, the light transmitter 10 and the light receiver 14 are spatially separated from one another, i.e. they each form closed, independent constructional units.

In the second embodiment shown in FIG. 2, the light transmitter and the light receiver are, in contrast, combined with one another to form a transceiver unit 36, i.e. the light receiver is integrated in the light transmitter. In this case, the optical lighting system 18 is simultaneously used as an optical imaging system 30. The reflected light 26 detected by the transceiver unit 36 is imaged onto the light sensitive region of the photosensitive element 32 via a semi-transmitting mirror 38.

As is shown in FIGS. 3 and 4, the diaphragm arrangement 20 serves to select optionally a first or a second light beam 40, 42 from the light 22 transmitted by the light source 16. This can, for example, be an upper light beam 40 (FIG. 3) and a lower light beam 42 (FIG. 4).

The diaphragm arrangement 20 preferably has an electronically controllable LCD shutter. Such a shutter can be switched very fast. In addition, with LCD shutters, the shutter opening can be sat practically as desired so that it is generally possible to produce light beams with different cross-sections perpendicular to the direction of radiation. Light beam cross-sections possible for the monitoring of the protected zone can, for example, be round, semi-circular or angular, in particular rectangular.

By a corresponding switching of the diaphragm arrangement 20, alternatively or alternately two (or more) different zones of a protected zone can be monitored, for example an upper zone, as is shown in FIG. 3, or a lower zone, as is shown in FIG. 4.

Accordingly, respectively different part regions of the reflector 12 are lit by the transmitted light beams 40, 42. It is therefore possible to use a reflector 12 having a single continuous reflector surface which has been selected to be so large that it in every case detects both light beams 40, 42. One can, however, likewise also use a reflector having two reflector surfaces separate from one another or even two reflectors separate from one another which are each associated with one of the light beams 40, 42.

A photo-sensitive element 32 having a single light-sensitive region 54 is provided in the light receiver 14 or 36 respectively for the detection of the first and second or of the upper and lower light beams 40, 42 respectively. The light beams 40, 422 are arranged offset to one another in a direction perpendicular to the direction of radiation, with them being able to be adjacent to one another, as shown in FIGS. 3 and 4, or being able to be spaced apart from one another, as shown in FIGS. 6 and 7. The light sensitive region 54 of the photo-sensitive element 32 has an elongate design in the direction parallel to the arrangement of the light beams 40, 42. With an alternate or alternative radiation of the light beams 40, 42, only a part region of the light sensitive region is lit by the reflected light.

It is possible to provide a reflector with a pattern of reflecting and non-reflecting regions in order to encode the reflected light beams 40, 42. Such an encoding of the light beams 40, 42 has the advantage that the light receiver 14 or 36 respectively can distinguish a light beam reflected by the reflector 12 from a non-encoded light beam which has erroneously been reflected at an object which has entered into the protected zone.

It is furthermore possible for two separate reflectors or reflector surfaces to be encoded with different patterns. The received light beams 40, 42 can likewise be distinguished from one another by such a different encoding.

When one or more encoded reflectors are used, the receiver must be made to be spatially resolving in order to be able to identify the encoding at the receiver side.

A receiver row having a plurality of receiver elements which each have an asymmetric pixel geometry, that is each have an elongate light-sensitive region, can be provided as the spatially resolving receiver, for example. The ratio of pixel height to pixel width can preferably be larger than 5. The respective light-sensitive region can have a size, for example, of 12 μm×250 μm.

FIG. 5 shows the use of the monitoring apparatus in accordance with the invention in accordance with the second embodiment (cf. FIG. 2) for the securing of a bending press. The bending press includes a lower tool 44 on which a workpiece 46 to be processed is arranged. An upper tool 48 can be moved in the vertical direction relative to the lower tool 44 in order to exert a corresponding force on the workpiece 46 for the processing thereof.

To avoid personal injury, in particular a jamming of body parts, a protected zone located between the upper tool 48 and the lower tool 44 has to be monitored. This is typically a region which extends parallel to a lower side 50 of the upper tool 48 facing the lower tool 44, the so-called bending line, and which has a spacing to the lower side 50 which corresponds to the lag path of the upper tool 48.

The transceiver unit 36 of the monitoring apparatus is attached to an end of the upper tool 48 by means of a first holder arm 52, while the reflector 12 is fastened to the opposite end of the upper tool 48 by means of a second holder arm 52.

As is shown in FIG. 6, the transceiver unit 36 alternatively transmits an upper light beam 40 or a lower light beam 42, with the light beams 40, 42 being spaced apart from one another. The spacing of the lower light beam 42 from the lower side 50 of the upper tool 48 substantially corresponds to the lag path of the upper tool 48, for example 10 mm to 14 mm. In contrast, the upper light beam 42 extends at a spacing of approximately 6 mm from the lower side 50 of the upper tool 48.

If the upper tool 48 approaches so closely to the lower tool 44 in a press bending process that the spacing between the upper tool 48 and the lower tool 44 amounts to less than the lag path, a monitoring of the intermediate space between the upper tool 48 and the lower tool 44 is no longer possible with the help of the lower light beam 42. Nevertheless, the spacing between the upper tool 48 and the lower tool 44 could still be sufficiently large to trap a finger in, for example.

In order to also still be able to effectively monitor an intermediate space between the lower tool 44 and the upper tool 48 lying within the lag path, a switching from the lower light beam 42 to the upper light beam 40 is provided. For this purpose, the diaphragm arrangement 20 is actuated such that now the upper light beam 40 is selected from the light of the light source 16 instead of the lower light beam 42 or that—if previously both light beams 40, 42 had always been selected alternately - now only the upper light beam 40 is selected.

In FIG. 6, not only the arrangement of the light beams 40, 42 offset with respect to one another is shown, but also the dimensioning of the light sensitive region 54 of the photo-sensitive element 32 of the transceiver unit 36 matched thereto. The light sensitive region 54 has a substantially rectangular design, with the width of the region 54 in the horizontal direction approximately corresponding to the width of the light beams 40, 42. The length of the light sensitive region 54 in a direction parallel to the offset arrangement of the light beams 40, 42, i.e. in the vertical direction in FIG. 6 and thus in the direction of movement of the upper tool 48, is in contrast at least so large that the light spots produced by the two light beams 40, 42 can still be detected.

If the extent of the light sensitive region 54 in the longitudinal direction is selected to be even larger, both light beams 40, 42 can even impact the light sensitive region 54 at any time and be detected by the light receiver 14 or 36 respectively when the upper tool 48 oscillates in the vertical direction, i.e. parallel to its direction of movement.

In order also to ensure a reliable detection of the radiated light beams 40, 42 on a horizontal oscillation of the upper tool 48, a plurality of photosensitive elements 32 can be arranged in a row next to one another with a parallel alignment of their light sensitive regions 54, as is shown in FIG. 7. For example, 150, 256 or 512 light sensitive regions 54 can be arranged next to one another. In this manner, a light beam 40, 42 oscillating along the row of the light sensitive regions 54 can also be reliably detected. Such an arrangement of a plurality of light sensitive regions 54 next to one another also makes the recognition and distinguishing of encoded light beams 40, 42 possible, as already explained.

It must still be noted with respect to the representation in accordance with FIGS. 6 and 7 that the light beams 40, 42 can also have a semi-circular shape in cross-section so that they together form a circular or oval cross-section.

Although the use of the monitoring apparatus in accordance with the invention has been described by way of example with reference to the securing of a bending press, the monitoring device can also be used in other areas, for example, for the monitoring of access. For example, a first light beam could be associated with a warning zone and a second light beam with an activated zone. The two light beams can therefore serve for the triggering of different types of warning signals.

The monitoring apparatus in accordance with the invention can also advantageously be used for the securing of further machinery which has a moving tool part. The monitoring apparatus can thus be attached to holding down devices of bending machines and paper cutters, to metal shears, to gates, roll-up gates, shear edges, etc. for the securing of the closing edges.

### Reference Numeral List

10 light transmitter

12 reflector

14 light receiver

16 light source

18 optical lighting system

20 diaphragm arrangement

22 radiated light

26 reflected light

30 optical imaging system

32 photo-sensitive element

34 control element

36 transceiver unit

38 semi-transmitting mirror

40 upper light beam

42 lower light beam

44 lower tool

46 workpiece

48 upper tool

50 lower side

52 holder arm

54 light sensitive region

1. An optical monitoring apparatus comprising a light transmitter (10; 36) for the transmission of at least two light beams (40, 42) offset substantially parallel to one another into a protected zone; and
a light receiver (14; 36) for the reception of the transmitted light beams (40, 42) and for the outputting of corresponding received signals,
wherein the light receiver (14; 36) has at least one photo-sensitive element (32) having an elongate light sensitive region (54) whose longitudinal direction is aligned parallel to the arrangement of the light beams (40, 42) perpendicular to the direction of transmission such that all radiated light beams (40, 42) can be completely detected by the light sensitive region (54); and
wherein a control circuit (34) is provided for the distinguishing of the light beams (40, 42) at the light receiver (14; 36) and causes the light transmitter (10; 36) to make a transmission of the light beams (40, 42) offset in time.

2. An apparatus in accordance with claim 1, characterized in that the light transmitter (10; 36) has a light source (16) and a diaphragm arrangement (20) by which a respective light beam (40, 42) to be transmitted can be selected from the light of the light source (16).

3. An apparatus in accordance with claim 2, characterized in that the diaphragm arrangement (20) has an electronically controllable intensity filter.

4. An apparatus in accordance with claim 2, characterized in that the diaphragm arrangement (20) has an LCD shutter.

5. An apparatus in accordance with claim 1, characterized in that the light beams (40, 42) adjoin one another or overlap one another at least regionally.

6. An apparatus in accordance with claim 1, characterized in that the light beams (40, 42) are spaced apart from one another.

7. An apparatus in accordance with claim 1, characterized in that the extent of the light sensitive region (54) is more than twice the size in the longitudinal direction of the light sensitive region (54) than the extent of the light beams (40, 42) at the location of the light receiver (14; 36); and in that the extent of the light sensitive region (54) perpendicular hereto substantially corresponds to the extent of the light beams (40, 42).

8. An apparatus in accordance with claim 1, characterized in that the light receiver (14; 36) has a plurality of photo-sensitive elements (32) which are arranged in a row next to one another with a parallel alignment of the light sensitive regions (54).

9. An apparatus in accordance with claim 8 characterized in that the arrangement of the plurality of photo-sensitive elements (32) extends within the plane perpendicular to the transmission direction of the light beams (40, 42) perpendicular to the offset arrangement of the light beams (40, 42).

10. An apparatus in accordance with claim 1, characterized in that the light receiver (14; 36) has a CMOS row.

11. An apparatus in accordance with claim 1, characterized in that the light transmitter (10; 36) and the light receiver (14; 36) are arranged at the same side of the protected zone and the transmitted light beams (40, 42) can be deflected in the direction of the light receiver (14; 36) by at least one reflector (12) arranged at the respectively opposite side of the protected zone.

12. An apparatus in accordance with claim 11, characterized in that a separate reflector (12) is associated with each light beam (40; 42)

13. An apparatus in accordance with claim 11, characterized in that at least one reflector (12), and in particular every reflector (12), has an encoding perpendicular to the offset arrangement of the light beams (40, 42).

14. An apparatus in accordance with claim 1, characterized in that the light receiver (36) is integrated into the light transmitter (36).

15. An apparatus in accordance with claim 1, characterized in that the light receiver (14) is arranged spaced apart from the light transmitter (10).

16. An apparatus in accordance with claim 1, characterized in that the apparatus is provided for attachment to an upper tool (48) of a bending press.

17. An apparatus in accordance with claim 16, characterized in that the light beams (40, 42) are arranged beneath one another beneath the bending line (50) of the upper tool (48).
